(19) United States
(12) Patent Application Publication
(10) Pub. No.: US 2011/0088921 A1
(43) Pub. Date: Apr. 21, 2011

(54) PNEUMATIC HAND TOOL ROTATIONAL SPEED CONTROL METHOD AND PORTABLE APPARATUS

(76) Inventors: Sylvain Forgues, Blainville (CA); Brigitte Labelle, Blainville (CA)

(21) Appl. No.: 12/974,064

(22) Filed: Dec. 21, 2010

Related U.S. Application Data
(63) Continuation-in-part of application No. 12/460,836, filed on Jul. 24, 2009.
(60) Provisional application No. 61/135,993, filed on Jul. 25, 2008.

(51) Int. Cl. B25F 5/00

(52) U.S. Cl. 173/1; 173/217

(57) ABSTRACT

The rotational speed of a pneumatic hand tool is adjusted in real time to maintain a selected speed level irrespective of exterior parameters affecting the performance of the tool. The apparatus is comprised of a rotational speed sensor installed directly on the tool, a digital microprocessor using control algorithms, and a valve to adjust the flow of air to the tool.

### CROSS-REFERENCE TO RELATED APPLICATION

This application is a C-I-P of application Ser. No. 12/460,836, filed Jul. 24, 2009 and which claims priority based on U.S. Provisional Application Ser. No. 61/135,993 filed Jul. 25, 2008.

### TECHNICAL FIELD

The present invention relates to a pneumatic hand tool rotational speed controller for controlling the operating rotational speed of a driven shaft of a pneumatic hand tool and its method of operation.

### BACKGROUND ART

Pneumatic hand tools are portable tools powered by compressed air and are used to perform specific operations such as cutting, grinding, sanding, polishing, deburring, drilling, and peening.

Pneumatic hand tools do not currently offer a method to display and control their rotational speed. They will therefore operate at their maximum speed if sufficient air is available. Since the attachment (ex: abrasive, drill bit, peening flap) used with the hand tool requires a specific speed for optimum performance, operators will often use a plurality of hand tools for different jobs.

It is possible to manually lower the pressure for the hand tool using a pressure regulator. However, this approach cannot maintain the speed under loading. Electro-pneumatic pressure regulators used with pressure transducers were developed to help stabilize the pressure but again had no way of responding to external variations. The electro-pneumatic pressure regulators with a feedback loop that have been presented in previous patents, see U.S. Pat. No. 4,644,848, use a pressure transducer as feedback to a controller. The problem with such an approach is that under heavy load, the relationship between applied pressure and rotation speed might become distorted. The pressure might therefore increase while the rotation speed of the tool might remain constant or even slow down.

### SUMMARY OF INVENTION

It is a feature of the present invention to use a rotational speed sensor directly attached to the pneumatic tool to measure the rotational speed of the tool to overcome this difficulty. Such has the further advantage of facilitating the use of the hand tools and attachments since the set rotational speed and actual rotational speed can be continuously displayed. This is a major advancement since all hand tool attachments are rated in terms of speed, not air pressure. With the present invention, if insufficient compressed air is available to maintain the desired rotational speed for the attachment, the controller can sound an alarm and shut down the tool to inform the operator of the problem thus preventing unwanted results.

The precise rotational speed control of pneumatic hand tools is very important in many industrial processes.

The present invention may be used, for example, for the removal of specific paint layers on a car body. In such embodiment, an abrasive attachment is rotated at a precise speed to remove the clear coat and main pigmentation layers on the surface of the part. The bottom coat sprayed directly to the metal must not be removed since it protects the metal from corrosion. This can be done by a skilled worker using the present invention by precisely controlling the rotation speed of the abrasive attachment.

Another use of the present invention is for the grinding of titanium materials without making sparks. The titanium dust produced during grinding can be ignited by a spark and cause a fire or explosion. By using the appropriate abrasive and coolant and by reducing the speed, it is possible to grind this material. Properly controlling the lower rotation speed will ensure that no dangerous sparks are produced.

Still another use for the present invention is for drilling holes in components. Many drill bits use special coatings or material to extend their performance and useful life. When the rotational speed of the drill bit is not known or properly controlled, the high heat produced by the drilling can burn the tip of the drill bit making it ineffective. A pneumatic hand tool with the speed control of the present invention will help drill bits be more effective and last longer.

A preferred use of the present invention is for the flapper peening of fatigue critical parts.

As is known in the art, peening is the process of impacting a metal component with small particles. The peening of the metal surface results in the material being stronger and tends to place the material in compression and relieve preexisting tensile stresses which may exist in the member. In other words, the impacting of the surface tends to place the member in compression and helps prevent fatigue, cracks and other imperfections in the surface from propagating through the surface to cause failure. The peening process is widely used in the aeronautical industry.

Conventional shot peening requires extensive blasting equipment and is not particularly suited to situations which require mobility of the equipment. Furthermore, in many such situations, the particles are not easily collected for recirculation. Rotary tools for shot peening are known in the art and are more adapted for applications requiring mobility. The tool will comprise a rotating shaft having drive means associated therewith and one or more flaps are attached to the shaft. Each flap has one or more hard particles or shot and the flap impacts on the work piece. Each impact produces a localized compressive stress on the surface for the reasons set forth above.

Conventional rotating peening tools are generally light weight hand tools which use a plurality of peening flaps mounted on the shaft. Each flap has one or more shot peening particles affixed to its free end and the flap is driven to impact the work surface as the flap is rotated. The art shows many different arrangements for the shot(s) on the rotating flap.

As in any treatment, it is important to have proper control associated with the rotary peening treatment. In particular, the speed of rotation is critical in this process. At the present time, this is extremely difficult to provide since no speed controller exists.

In particular, one operator may hold the tool closer to the work piece and thus, the peening flaps strike the member to be treated at a slower pace—i.e. the rotational speed is decreased as the flap expends more energy to move past the work piece. Inversely, if the tool is held at a greater distance from the work piece whereby the outer portions of the flaps are utilized, the speed will be greater. Furthermore, the rotary peening apparatus frequently uses compressed air which often is provided through large compressors feeding several lines. When the demand on the compressor increases, the pressure in the lines might drop affecting the speed of the rotary peening apparatus.

Both the operator stability and the compressed air pressure variation, as well as several other factors, will have an impact on the speed of the rotary peening apparatus. This will have an influence on the energy transferred to the material and must therefore be kept as constant as possible to ensure a quality peening process.

It is a feature of the present invention to provide a rotary speed control apparatus to control the rotational speed of the drive shaft of a pneumatically driven tool and ensure proper treatment of the member being treated.

It is a further feature of the present invention to provide a method that continuously monitors and controls the speed of rotation of the drive shaft of a pneumatically driven tool to ensure that the operator properly treats the member to be treated.

According to the above features, from a broad aspect, the present invention provides a pneumatic hand tool rotation speed controller for monitoring and adjusting the rotational speed of a pneumatic driven hand tool in real time. The rotational speed controller receives real time signals from a sensor secured to the hand tool and monitors actual rotational speed of a driven shaft of the hand tool. Drive means is provided to drive the driven shaft. The drive means is controlled by the rotational speed controller to increase or decrease the rotational speed of the driven shaft to substantially maintain a desired optimal rotational speed.

According to a still further broad aspect of the present invention there is provided a method of controlling the operating rotational speed of a driven shaft of a pneumatic hand tool. The pneumatic hand tool has a sensor to monitor the actual rotational speed of the driven shaft. The method comprising the steps of inputting into a micro-controller a reference signal representative of a desired optimal rotational speed of the hand tool. The method further comprises feeding real time signals to the microcontroller by the sensor representative of the actual rotational speed of the driven shaft when the hand tool is operational. The microcontroller compares the real time signals with the reference signal to generate a control signal to control the flow of air from a compressed air supply line connected to the hand tool to substantially maintain a desired optimal rotational speed of the driven shaft of the hand tool.

The apparatus of the present invention may include any suitable pneumatic hand tool, many of which are commercially available. The type of work performed with the hand tool is irrelevant to the practice of the present invention. The controller may be incorporated directly into the tool along with the rotational speed sensor. It may also be offered as a separate unit. In this case, a speed sensor would be attached to the pneumatic hand tool through a special attachment fitting and the sensor signal relayed back to the microcontroller through a wire or using a wireless system.

The controller of the present invention is designed to receive a signal from the sensor measuring the speed of the shaft and to increase and/or decrease the speed in response to the measurement.

According to the present invention, there is provided a control device which maintains the required operating speed of the rotary peening tool.

Maintaining the speed of the shaft is extremely important, particularly in cases where the rotational speed has a direct impact on the quality, the safety, the effectiveness and/or the repeatability of the process.

### BRIEF DESCRIPTION OF DRAWINGS

Having thus generally described the invention, reference will be made to the accompanying drawings illustrating an embodiment thereof, in which:

FIG. 1 is a perspective view illustrating a pneumatic hand tool with an incorporated rotational speed control apparatus.

FIG. 2 is a perspective view illustrating a typical embodiment of a rotary speed control apparatus with mandrel and flaps for a rotary peening operation.

FIG. 3 is a block diagram illustrating the speed control apparatus according to the present invention in association with a mechanical air tool.

### DESCRIPTION OF PREFERRED EMBODIMENTS

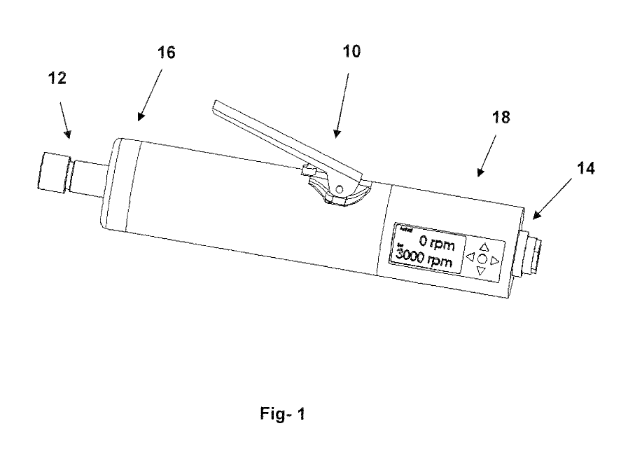

Referring to FIG. 1 in greater detail and by reference characters thereto, there is illustrated a pneumatic hand tool 10 with the incorporated speed control feature of the present invention. The rotary speed controller 18 can be connected to a conventional pneumatic rotary hand tool 10 that uses a rotary vane motor or to any other type of rotary pneumatic motor

It will be understood that the above hand tool 10 is of a type well known in the art and is for purposes of illustration only. The tool 10 has an arbour end 12 and an air inlet end coupling 14. In this preferred embodiment, the speed controller 18 is incorporated into the hand tool along with a speed sensor 16. This integrated approach maximizes the response time of the controller since it can adjust the air intake volume to any changes in rotary speed of the tool.

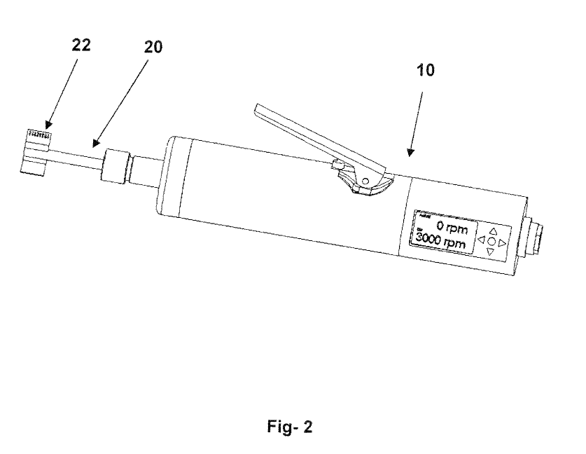

FIG. 2 illustrates the use of the pneumatic hand tool 10 with the integrated rotational speed controller of the present invention to perform flapper peening. In this case, an attachment in the form of a shaft 20 with flaps 22 is installed at the arbor end of the tool peening. The flaps need to rotate at a constant speed to impart a specific amount of energy into the part being peened. Any higher or lower rotational speed will have an impact on the energy transferred and therefore to the quality of the process. The controller ensures that the rotational speed is continuously monitored and adjusted even if the operator technique changes or air supply varies.

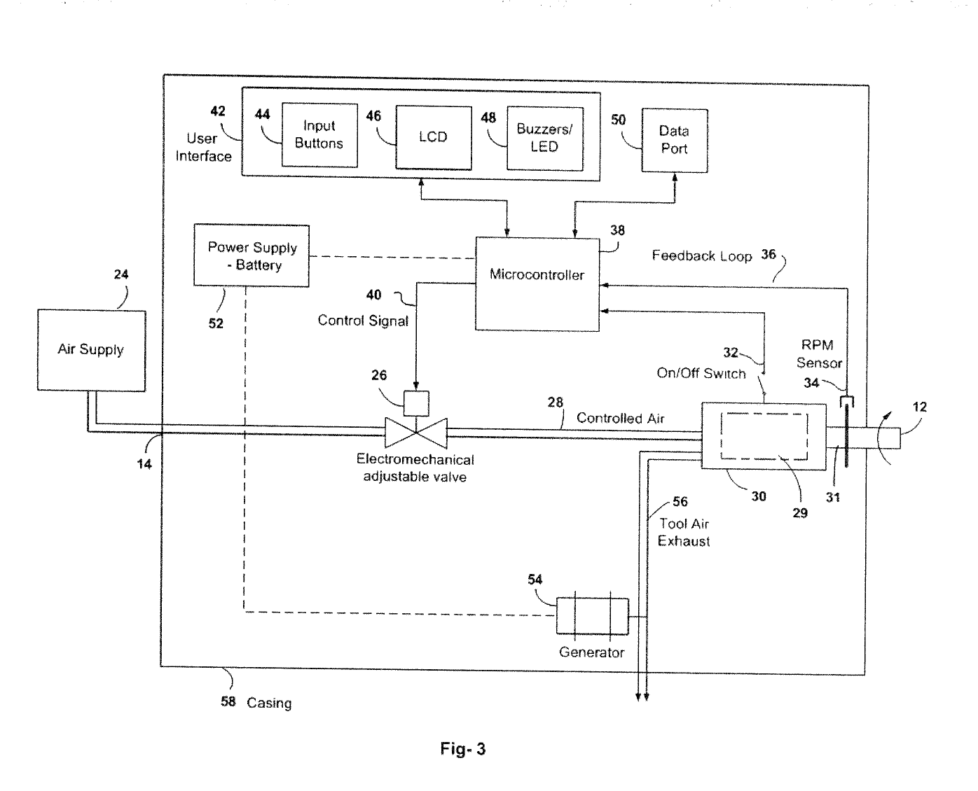

Referring to FIG. 3, an air supply line 24 is connected to the air inlet end coupling 14 and feeds an adjustable valve 26. The valve 26 may be of any electromechanical type without departing from the scope of the invention. Possible types are the diaphragm type or the proportional solenoid type. It may also include additional on-off solenoids to properly control the flow of air in the conduit 28 to the pneumatic motor 29 of the air tool 30. Depending on the desired rotational speed range of the pneumatic tool, the pneumatic motor 29 may be hooked up to a gearing system not shown, but obvious to a person skilled in the art.

An on/off switch 32 may be used to start and stop the control process. A rotational speed sensor 34 measures rotations per minute (RPM) of the drive shaft 31 and may be installed at any location on the mechanical air tool. Preferred locations are either before or after the pneumatic motor 29. The rotational speed sensor may be of several different types including the optical type, the laser type and the induction type. A speed signal 36 is fed back to a microcontroller 38 either through a signal wire or through a wireless system. The microcontroller 38 compares the actual speed with the desired speed and adjusts the valve opening using the control signal 40. This is done at a very high sampling rate using control algorithms. Control algorithms may include PID algorithms, feed forward algorithms or fuzzy logic algorithms used independently or combined for greater performance.

The desired speed of the tool is selected through a user interface 42 which may include a number of input buttons on the tool, a liquid crystal display (LCD) 46, buzzers and/or Light Emitting Diodes (LED) 48 or other interactive devices. The buzzers and LEDs are used to inform the operator of a important situation. For example, if the air available to the tool is insufficient to allow the controller to maintain the desired rotational speed. In this case, the microprocessor may stop the rotation of the tool, sound the buzzer and illuminate some LEDs to warn the operator. Both the display and the buttons may be combined through a touch screen interface. The LCD displays information relevant to the operator such as the actual and desired speed as well as any other important parameter.

When required, the tool may include a data port 50 to continuously save process parameters. These parameters may include the date, time, the desired speed, the actual speed, the name of the operator, a description of the task performed or any other data relevant to the operator to the quality control organization. The data logged may be saved to internal memory or to removable memory such as USB or SD devices. The data port may also be used to update the microprocessor software and save useful process and/or operator information in the controller. For example during the flapper peening process, an operator would utilize the tool on a test piece of material until a satisfactory result is achieved. The parameters for that operator could then be entered into the controller to permit operation under substantially identical conditions. A number of different operators could save their data into the tool in order to each operate at their optimum condition.

The controller may use an external power supply or a battery 52 to operate. A generator 54 may also be hooked up and driven by the tool exhaust 56 to recharge the battery.

The pneumatic rotational speed controller may be directly incorporated into the casing 58 of the pneumatic tool 10. In this case, because of the electronics, the casing may be NEMA approved or even explosion proof. However, the controller may be physically separate from the pneumatic tool. As a minimum, the rotational speed sensor must be attached to the pneumatic tool. In this case, the sensor and controller would be connected by a sensor wire or through a wireless connection.

It is within the ambit of the present invention to cover any obvious modifications of the preferred embodiment described herein, provided such modifications fall within the scope of the appended claims.

We claim:

1. A pneumatic hand tool rotation speed controller for monitoring and adjusting the rotational speed of a pneumatic driven hand tool in real time, said rotational speed controller receiving real time signals from a sensor secured to said hand tool and which monitors actual rotational speed of a driven shaft thereof, drive means to drive said driven shaft, said drive means being controlled by said rotational speed controller to increase or decrease the rotational speed of said driven shaft to substantially maintain a desired optimal rotational speed.

2. A pneumatic hand tool rotational speed controller as claimed in claim 1 wherein said rotational speed controller is a microcontroller having a user interface to input into a memory of said microcontroller said desired optimal rotational speed as a reference signal.

3. A pneumatic hand tool rotational speed controller as claimed in claim 2 wherein said drive means is a pneumatic motor driven by a compressed air supply line through an adjustable valve, said adjustable valve being controlled by a control signal from said microcontroller to control the flow of compressed air to said hand tool, said control signal being adjusted depending on discrepancies between said real time signals and said reference signal.

4. A pneumatic hand tool rotational speed controller as claimed in claim 3 wherein said adjustable valve is an electromechanical valve.

5. A pneumatic hand tool rotational speed controller as claimed in claim 2 wherein said sensor is one of an optical sensor, a laser type sensor or an induction type sensor, said real time signals from said sensor being fed to said microcontroller through a wire connection or a wireless system.

6. A pneumatic hand tool rotational speed controller as claimed in claim 3 wherein said microcontroller has a control algorithm to monitor said real time signals which are generated by said sensor at a high rate.

7. A pneumatic hand tool rotational speed controller as claimed in claim 2 wherein said user interface further comprises display and alarm means to inform an operator person of one or more operating situations of said hand tool and of an air supply connected thereto.

8. A pneumatic hand tool rotational speed controller as claimed in claim 2 wherein there is further provided a data port to continuously log data from said hand tool when in operation, said logged data pertaining to an operator person, said logged data being fed to said memory of said microcontroller for further use.

9. A pneumatic hand tool rotational speed controller as claimed in claim 2 wherein said microcontroller has a battery power supply and a generator driven by an air exhaust line of said hand tool and connected to said battery to recharge said battery.

10. A pneumatic hand tool rotational speed controller as claimed in claim 1 wherein said pneumatic hand tool rotational speed controller is incorporated into a casing of said hand tool.

11. A pneumatic hand tool rotational speed controller as claimed in claim 1 wherein said rotational speed controller is located in a portable housing separate from said hand tool.

12. A method of controlling the operating rotational speed of a driven shaft of a pneumatic hand tool, said pneumatic hand tool having a sensor to monitor the actual rotational speed of said driven shaft, said method comprising the steps of:
i) inputting into a microcontroller a reference signal representative of a desired optimal rotational speed of said hand tool;
ii) feeding real time signals to said microcontroller by said sensor representative of the actual rotational speed of said driven shaft when said hand tool is operational; and
iii) comparing, in said microcontroller, said real time signals with said reference signal to generate a control signal to control the flow of air from a compressed air supply line connected to said hand tool to substantially maintain a desired optimal rotational speed of said driven shaft of said hand tool.

13. A method as claimed in claim 12 wherein said control signal is fed to an adjustable valve means to control the air flow in said air supply line connected to said hand tool.

14. A method as claimed in claim 13 wherein there is further provided the step of feeding data from said hand tool when operational to a data port to continuously log data from said hand tool, and inputting in a memory of said microcontroller at least some of said logged data.

15. A method as claimed in claim 13 wherein there is further provided the step of automatically displaying operational conditions of said hand tool and generating an alarm condition to inform a user person of one or more operating situations of said hand tool and of said air supply line.

16. A method as claimed in claim 12 wherein there is further provided prior to step (i) the steps of securing a work performing attachment to an arbour end of said driven shaft of said hand tool, operating said work performing attachment on a test piece of material until a satisfactory result is achieved, and analyzing the operating parameters of said tool when said satisfactory result is achieved to obtain said reference signal.

17. A pneumatic hand tool in combination with the rotational speed controller as defined in claim 1.

18. A pneumatic hand tool as claimed in claim 17 wherein said hand tool is a peening hand tool having a peening attachment secured to said driven shaft to impact the surface of a metal piece to increase the strength of the metal piece by placing the metal piece in compression and relieving tensile stresses.
